(19) United States
(12) Patent Application Publication
(10) Pub. No.: US 2006/0036473 A1
(43) Pub. Date: Feb. 16, 2006

(54) GPS mobil equipment insurance method, apparatus, and product

(75) Inventor: Don Taylor, Salt Lake City, UT (US)

Correspondence Address: MARCUS G THEODORE, PC, 466 SOUTH 500 EAST, SALT LAKE CITY, UT, 84102, US

(73) Assignee: Equipment GPS Protection, LLC, Salt Lake City, UT (US)

(21) Appl. No.: 11/199,624

(22) Filed: Aug. 9, 2005

Related U.S. Application Data
(60) Provisional application No. 60/600,608, filed on Aug. 11, 2004.

(51) Int. Cl. G06Q 40/00

(52) U.S. Cl. 705/4; 701/213

(57) ABSTRACT

A GPS Mobil Equipment Insurance Method, Apparatus and Insurance Product for mobile equipment adapted with GPS systems comprising: inputting into a computer processor a database of mobile equipment adapted with GPS systems from all GPS manufacturers within a geographical area, including data containing, but not limited to the name of the owner, the mailing address, type, year, and brand of equipment, and any equipment identification number; tracking the status of said equipment, and computer processing the database of mobile equipment to generate a discounted rate and providing an all risk insurance policy covering the GPS manufacturer and owner of mobile equipment adapted with GPS systems.

### RELATED APPLICATIONS

This application is a continuation-in-part of the provisional patent application entitled “GPS Mobil Equipment Insurance Method, Apparatus, and Product” filed Aug. 11, 2004 and assigned Ser. No. 60/600,608.

### BACKGROUND OF THE INVENTION

1. Field

This invention relates to methods and apparatus for insuring mobile equipment from all risk perils. More particularly, it relates to a method, apparatus and product to insure the owner and/or GPS manufacturer of mobile equipment adapted with a GPS system from loss.

2. State of the Art

Heavy equipment theft losses exceeded $1 billion last year in the United States alone, according to the National Equipment Register (2002). This report goes on to say that between 10 and 15 percent of all stolen equipment is ever recovered. Over 50% of all heavy equipment losses are due to theft. Since 1996, heavy equipment theft has increased by upwards of 20% annually in the United States. Sophisticated, organized crime rings are the main perpetrators according to the National Insurance Crime Bureau (2002). On average it takes 10 to 15 minutes for a thief to steal heavy equipment. It takes several days for the same theft to be discovered. The low recovery rate makes critical the emphasis on theft prevention; see Police research Series, Paper 117 (1999).

To properly protect this equipment, it must be immobilized every night. In addition, immediate action must be taken if it is stolen. A number of GPS systems have been designed for installation on mobile heavy equipment for tracking and immobilization when not in use.

Presently, there is no method for providing discounted all risk insurance coverage for owners of mobile equipment employing these global positioning systems. This is because the equipment owner would have to list by separate schedule equipment having GPS systems and that which did not; resulting in combined coverage, and therefore little or no rate reduction. The process of reducing the mobile equipment rate on a schedule with GPS equipment and non GPS also can not happen for reason that the non GPS equipment is subject to theft without any protection. As such, the non GPS equipment will pollute the sample in the study, thereby preventing actuarial calculation of an overall all risk loss discount.

The method, apparatus and product described below provide such discounted all risk insurance coverage.

### SUMMARY OF THE INVENTION

The invention comprises a method and apparatus to issue a master all risk insurance policy to the manufacturer of GPS systems tied to GPS systems installed on mobile equipment. Thus only GPS scheduled equipment is covered from all risk theft, fire, wind, and any peril under a single rate. As the inland marine insurance rate for mobile equipment is rated substantially for the insured peril of theft, a significant discounted rate can be provided by the employment of GPS systems with this mobile equipment. Credits to reduce insurance premiums are given for the following reasons:
1. The experience for the risk has been one of little or no claim activity. This is accomplished with little or no help from the insured. In other words, by the luck of the draw. On the other hand, the insured may take an active part in adhering to thorough insurance engineering recommendations. Theoretically the latter is more effective over longer periods of time.
2. Risk reducing items, such as building fire sprinklers, fire extinguishers, driver and passenger airbags, anti lock brakes, seat belts, burglar alarms will also develop credits to reduce insurance premiums. These items when installed can have a large to minor impact in the reduction of risk. The insurance industry has used the above methods for allowing credits. The industry allows a credit for fire sprinklers properly installed and functioning which could 30% or higher. In all cases the risk reduction devices when installed provide a risk reduction to the whole item insured. For example when a burglar alarm is installed it provides safety for the entire premises. Also fire sprinklers provide protection against fire for the entire building. It is this entirety concept and the performance of the risk reduction device that increases the credits allowable.
   Insurance companies have been reluctant to offer any substantial credits for GPS units installed in mobile equipment for reason that the risk cannot currently be isolated to warrant credit allowances. As such there are no actuary tables or methods of isolation in order to develop those needed tables. There are a few company underwriters, which have given 3 to 5%. This however is very low considering the protection, which is offered by the GPS device. The main and devastating peril, which occurs to equipment, is that of theft. In fact the insurance rate is loaded over 50% for the theft exposure. To only offer 3 to 5% proves the theory that in order to apply the credit that is deserved the equipment containing the GPS device has to be isolated and separately listed. If this isolation does not occur the insurance clients are saddled with small to no credit offerings.

Inland Marine is the term used to cover equipment. It is common knowledge that equipment of all kinds and values are located on the same schedule on the policy. For this reason, equipment with GPS protection and without is found on the same Schedule. This process pollutes the actuarial data needed to develop worthy credit programs. Thus, it is essential to isolate the sample for actuarial as well as underwriting purposes. This currently is not being accomplished by the insurance industry before applicant's invention.

The first part of the process is to isolate the GPS equipment from the equipment not having GPS units. This is done by creating a new reduced rate GPS all risk insurance policy in the name of the manufacturer, or revising the schedules of an existing all risk insurance policy to isolate GPS scheduled equipment in the owner's name (the scheduled equipment listed must have verification that the GPS equipment was installed and is functioning). Manufacturer as used herein is the Manufacturer of the GPS device. Once the GPS equipment is installed and functioning, the equipment owner can then: a) elect to add the equipment to his certificate on the GPS all risk insurance policy provided by the manufacturer, or b) reduce the premium of his existing re-scheduled all risk policy. The certificate will function similarly to that of an insurance policy, giving the same protection. The one exception is that the rate will be reduced for reason that the sample of GPS device equipment is isolated warranting the credit reduction.

The method must utilize the physical apparatus of a GPS device. The GPS system not only tracks the location of the mobile equipment, but generally employs an automatic alarm and disabling feature during predefined hours, or on demand. Equipment relocation during off-hours is tracked and suspicious activities immediately reported to the machine's owner and/or security and law enforcement personnel. This reporting is done automatically similar to a silent alarm and is undetectable, effective, and reliable to provide around the clock surveillance. More particularly, the GPS device has the following features:

The anti-theft technology uses a hardware unit mounted on the customer's asset. The hardware unit contains a Global Positioning System (GPS) receiver and a wireless communication radio. Both the GPS receiver and wireless communication radio have an antenna, and in some cases the two antennas are combined into a single one.

The anti-theft technology provides any and all of the following protection methods:
1. Wireless reporting of the unit's GPS location at predefined times.
2. Wireless reporting of the unit's GPS location as requested on demand.
3. Wireless reporting of the GPS location and/or an alarm when the asset's movement exceeds a predefined distance or boundary. This feature is sometimes called a “geofence” or “virtual fence”.
4. Wireless reporting of the GPS location and/or an alarm when the asset is started or its key switch is turned at unauthorized times. These unauthorized times are specified by the customer.
5. Reporting of the unit's GPS location at predefined times
6. Reporting of the unit's GPS location as requested on demand
7. Reporting of the GPS location as an alarm condition when the asset's movement exceeds a predefined distance. This feature is sometimes called a “geofence”.
8. Reporting of the GPS location as an alarm condition when the asset is started or the key switch is turned at unauthorized times. These unauthorized times are specified by the customer.
   As an option, though not required for the system to work, the detecting of an alarm condition may send a notification to a number of different mediums. These include, but are not limited to: email, text messaging, pagers, and websites.

The first step of the method is to gather, prepare, and maintain sufficient GPS equipment data to actuarially compute a rate reduction for mobile equipment all risk insurance coverage to be written and provided to owners of GPS systems installed on their mobile equipment. The method next involves the installation of GPS systems on mobile equipment by the GPS systems manufacturer, which is tested for operability by transmission via satellite to the GPS manufacturer's central control facility. The anti-theft GPS technology employed uses a hardware unit mounted on the customer's equipment asset. It has a remote tracking unit with a Global Positioning System (GPS) receiver and a wireless communication radio. Both the GPS receiver and wireless communication radio have an antenna, and in some cases the two antennas are combined into a single one. As an option, though not required for the system to work, the detecting of an alarm condition may send a notification to a number of different mediums. These include, but are not limited to: email, text messaging, alphanumeric pager, and websites. The GPS system sends a signal to the GPS manufacturer's central control facility monitoring unit once correctly installed. This GPS manufacturer's central control facility then transmits the position, type, and equipment operation data to an insurance company receiver to update its GPS mobile equipment database with the latest data. From the database pool of GPS mobile equipment data, an actuarial rate is generated by the insurance receiver for issuing an insurance policy. The insurance policy is issued to the GPS system manufacturer or equipment owner. This insurance policy is issued and the discounted rate transmitted to the GPS mobile equipment central control facility to add this insurance charge to its GPS monitoring charges for payment by the owner and operator for all risk insurance coverage. Premiums can also be billed individually to the owners of the equipment who are the certificate holders on the master policy.

The apparatus for providing GPS mobile equipment with discounted all risk insurance coverage thus comprises: a plurality of GPS transmitters installed in designated vehicles in communication with an orbital satellite GPS receiving and relay system. The GPS receiving and relay system transmits the status of the mobile equipment to the GPS manufacturer's equipment control center. The manufacturer's equipment control center has transmitters to transmit electronic information regarding the location, type of mobile equipment unit, and condition of the same to corresponding receptors and transmitters in an insurance control center. The insurance control center receives the GPS electronic information from the manufacturer's equipment control center and enters the same into a database. This database is entered into a computer in the insurance control center. This computer has an actuarial program to generate a discount insurance rate for all risk insurance covering the GPS mobile equipment. This discount all risk insurance rate is then transmitted via a computer transmitter to send an all risk mobile equipment discount rate insurance policy covering both the GPS system operator and owner to the GPS control center. The insurance center then bills the owner.

Owners and Dealers are therefore the certificate holders on a master all risk insurance policy. Equipment is moved to a single schedule on the master policy once the GPS is properly installed and functioning. Using installation of the GPS device provides a unique insurance method, apparatus and product or credit structure on existing policies not currently offered. The isolation process purifies the data pool and allows the actuarial theory to be applied. Thus, a national rate and not territorial rate, which are largely affected based on local theft exposure is provided. This simplifies the rating as well as the underwriting process.

With the introduction of this business process method, apparatus and product patent the sample can be actuarially proven. This being the case the rate for mobile equipment will be substantially reduced. Rates provided by an A++ insurance company implementing this invention for the first time are as follows:
w/out GPS—0.95 to 1.05 per $100 of value
w GPS—0.43 to 0.55 per $100 of value

Although coverage is automatically electronically provided in unalterable form, a written policy may also generated and transmitted to the GPS mobile equipment manufacturer and/or owner. The invention has been designed to accomplish the following:
1. Reduce substantially the insurance premiums for mobile equipment.
2. Simplify the rating procedure for insurance companies.
3. Provide incentive to the sale of GPS systems for mobile equipment.

The above data is preferably received on-line via the internet, or in a variety of media types, including tapes, cartridges, discs, etc. and is integrated with a data integration system to include all relevant data, even though this initially generates redundant entries. Once the GPS mobile equipment insurance data is entered, it generally doesn't change unless the unit is damaged.

The other information varies continuously, and has to be periodically updated and inputted by the GPS equipment manufacturer to reflect the current equipment status and identity of each unit. The GPS all risk equipment coverage begins on the date of installation or an operable GPS unit, and ends as of the date the equipment is sold or transferred. Continuous monitoring insures that uninstalled GPS equipment is not covered, and that the current owner is covered as an additional insured. This policy rate lowers the overall cost of providing the all risk discount GPS insurance to the owner by reducing risk of loss, and administrative fees passed on to the owner. For example, monthly entries are inputted by the GPS equipment manufacturer via screens gathering the necessary information for transmittal through the internet or GPS network system. This information is thus preferably reported on standardized combined or separate interactive computer screens.

The above method and apparatus thus provides a simple means for meeting the needs of both the GPS equipment manufacturer and equipment owner with discounted all risk insurance unique as to the time coverage begins and ends and its cost.

### DESCRIPTION OF THE DRAWINGS

FIG. 1 illustrates a schematic flow diagram of a preferred method.

FIG. 2 illustrates an example of the apparatus equipment employed.

### DESCRIPTION OF THE ILLUSTRATED EMBODIMENTS

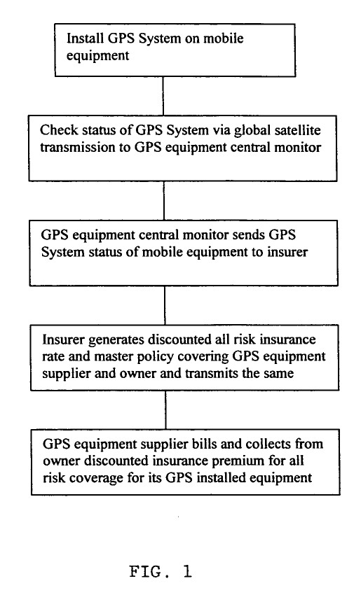

FIG. 1 illustrates a schematic flow diagram of the basic preferred overall method described above.

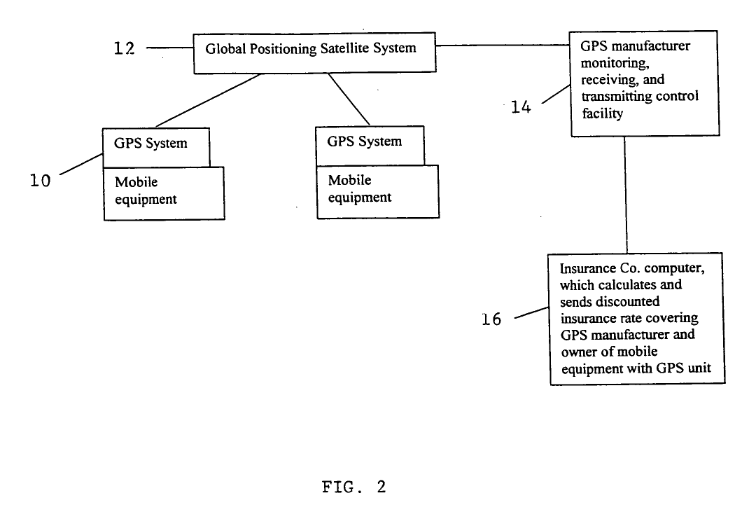

FIG. 2 illustrates an example of the apparatus equipment employed. GPS Systems 10 are affixed to mobile equipment to be insured. These GPS Systems 10 are in communication with a Global Positioning Satellite System 12, which relays information from the GPS Systems 10 to the GPS manufacturer control center 14. The GPS manufacturer control center 14 is in turn in communications with the Insurance agency or Insurance Company computer 16 which calculates and sends discounted insurance rates for a master policy covering both the GPS manufacturer and the owner of the mobile equipment with all risk peril insurance.

Although the foregoing specification refers to the illustrated embodiments, it is not intended to restrict the scope of the appended claims. The claims themselves recite the features deemed essential to the invention.

I claim:

1. A GPS Mobil Equipment Insurance Method comprising:
a. inputting into a computer a database of GPS equipment data losses,
b. inputting a software program into the computer to actuarially compute a rate reduction for GPS mobile equipment all risk insurance coverage,
b. installing GPS systems on mobile equipment to be insured,
c. testing the GPS systems for operability by transmission via satellite to a GPS manufacturer's central control facility,
d. issuing a new reduced premium all risk insurance policy or reducing the premium of an existing insurance policy to the owner of mobile equipment installed with GPS systems.

2. A GPS Mobile Equipment Insurance Method according to claim 1, wherein the GPS system has a remote tracking unit with a Global Positioning System (GPS) receiver and a wireless communication radio.

3. A GPS Mobile Equipment Insurance Method according to claim 2, wherein both the GPS receiver and wireless communication radio have an antenna.

4. A GPS Mobile Equipment Insurance Method according to claim 3, wherein the two antennas are combined into a single antenna.

5. A GPS Mobile Equipment Insurance Method according to claim 1, wherein the GPS system:
a. Reports the unit's GPS location at predefined times,
b. Reports the unit's GPS location as requested on demand,
c. Reports the GPS location as an alarm condition when the mobile equipment's movement exceeds a predefined distance.
d. Reports the GPS location as an alarm condition when the mobile equipment is started or the key switch is turned at unauthorized times.

6. A GPS Mobile Equipment Insurance Method according to claim 5, wherein the unauthorized times are specified by the owner.

7. A GPS Mobile Equipment Insurance Method according to claim 5, wherein the report of an alarm condition is sent in a number of different mediums, including, but are not limited to: email, text messaging, alphanumeric pager, and websites to a GPS manufacturer's central control facility monitoring the installed GPS System.

8. A GPS Mobile Equipment Insurance Method according to claim 7, wherein the GPS manufacturer's central control facility transmits the position, type, and equipment operation data to an insurance company receiver to update its GPS mobile equipment database.

9. A GPS Mobile Equipment Insurance Method according to claim 1, wherein an actuarial rate is generated by the insurance receiver for the newly issued reduced premium all risk insurance policy or reduced premium of an existing insurance policy to the owner of mobile equipment installed with GPS systems policy covers both the manufacturer and the owner.

10. A GPS Mobile Equipment Insurance Method according to claim 9, wherein the insurance policy is issued or the schedules of an existing policy amended at the discounted rate and transmitted to the GPS mobile equipment central control facility to add the discounted rate to its GPS monitoring charges for payment by the owner and operator for all risk insurance coverage.

11. A GPS Mobile Equipment Insurance Apparatus for providing GPS mobile equipment with discounted all risk insurance coverage comprising:
a. a plurality of GPS transmitters installed in designated vehicles,
b. an orbital satellite GPS receiving and relay system in communication with the GPS transmitters,
c. a GPS manufacturer's equipment control center with receivers, which receive the status of the mobile equipment transmissions, and transmitters to transmit electronic information regarding the location, type of mobile equipment unit, and condition of the same,
d. an insurance control center with corresponding receptors and transmitters to receive the GPS electronic information from the manufacturer's equipment control center,
e. a database in the insurance control center of the location, type of mobile equipment unit and condition of the same,
f. a computer in the insurance control center into which the database is entered, and
g. an actuarial program entered into the computer to generate a discount insurance rate for all risk insurance covering the GPS mobile equipment, which is then transmitted via the computer transmitter to send an all risk mobile equipment discount rate for an insurance policy covering both the GPS system operator and owner to the GPS control center.

12. A GPS Mobile Equipment Insurance Apparatus according to claim 11, wherein the GPS manufacturer's equipment control center adds the price of the discounted all risk insurance rate to the GPS monitoring fee paid by the owner of the GPS mobile equipment to provide Owners and Dealers as certificate holders a new or an existing master all risk insurance policy in an electronically unalterable form.

13. A GPS Mobile Equipment Insurance Apparatus according to claim 12, wherein a written policy is generated and transmitted to the GPS mobile equipment manufacturer and/or owner.

14. A GPS Mobile Equipment Insurance Apparatus according to claim 11, wherein the information is received on-line via the global information network, or in a variety of media types, including tapes, cartridges, discs, etc. and is integrated with a data integration system to include all relevant data, even though this initially generates redundant entries.

15. A GPS Mobile Equipment Insurance Apparatus according to claim 11, wherein the entered GPS mobile equipment insurance information is not changed unless the unit is damaged, lost, or destroyed.

16. A GPS Mobile Equipment Insurance Apparatus according to claim 11, wherein information other than the entered GPS mobile equipment insurance information varies continuously, and is periodically updated and inputted by the GPS equipment manufacturer to reflect the current equipment status and identity of each unit.

17. A GPS Mobile Equipment Insurance Apparatus according to claim 11, wherein the GPS all risk equipment coverage begins on the date of installation of an operable GPS unit, and ends as of the date the equipment is sold or transferred.

18. A GPS Mobile Equipment Insurance Apparatus according to claim 11, including continuous computer monitoring to insure that uninstalled GPS equipment is not covered, and that the current owner is covered as an insured.

19. A GPS Mobile Equipment Insurance Apparatus according to claim 11, wherein monthly entries are inputted by the GPS equipment manufacturer via screens gathering the necessary information for transmittal through the global information network or GPS network system for reporting on standardized combined or separate interactive computer screens.

20. GPS Mobile Equipment insurance generated in accordance with the method of claim 1.
